(19) United States
(12) Patent Application Publication
(10) Pub. No.: US 2009/0055545 A1
(43) Pub. Date: Feb. 26, 2009

(54) Roles and relationship based security in a group-centric network

(76) Inventor: Nelson Nicola Saba, Orlando, FL (US)

Correspondence Address: CARR & FERRELL LLP, 2200 GENG ROAD, PALO ALTO, CA, 94303, US

(21) Appl. No.: 12/012,796

(22) Filed: Feb. 4, 2008

Related U.S. Application Data
(60) Provisional application No. 60/899,092, filed on Feb. 2, 2007.

(51) Int. Cl. G06F 15/16

(52) U.S. Cl. 709/229

(57) ABSTRACT

Exemplary systems and methods for providing security in a group-centric network are provided. In exemplary embodiments, a request to access a webpage associated with a group or individual is received. The user security level for a user requesting access to the webpage is then determined. One or more security settings associated with data on the webpage is also determined. Based on the user security level and the one or more security settings, an appropriate level of access and functionality for data on the webpage is provided to the user.

### CROSS-REFERENCE TO RELATED APPLICATIONS

The present application claims benefit of U.S. Provisional Patent Application No. 60/899,092 filed Feb. 2, 2007, and entitled “Group-Centric Social Network,” which is hereby incorporated by reference. The present application is also related to co-pending U.S. patent application Ser. No. 11/728,218 filed Mar. 23, 2007, and entitled “Creation of Organizational Hierarchies in a Social Network via Handshake Mechanisms,” which is hereby incorporated by reference.

### BACKGROUND

1. Field of the Invention

Embodiments of the present invention are directed to networking security and more particularly to roles and relationship based security in a network.

2. Related Art

Presently, users may utilize social networks to communicate with others socially. These social networks are typically a collection of individuals accessing a single social network host, and typically represent both a collection of ties between people and strength of those ties. In some embodiments, the social network is a map of relationships between individuals, which indicate ways in which individuals are connected through various social familiarities ranging from casual acquaintance to close familial bonds, for example.

Typically, each individual within the social network has their own webpage on which any information the individual desires to present may be posted. Some information on the webpage may be private, such that only those with relationships with the individual can view the private information. Other information may be public, such that any member of the social network may be able to view the public information.

Networks of generic organizations may also be present on the Internet. However, these networks do not provide security based on different roles and relationships of users and groups within the network.

### SUMMARY OF THE INVENTION

Embodiments of the present invention provide systems and methods that base security on roles and relationships of the individual users of a group-centric network. In exemplary embodiments, a request to access a webpage or profile page associated with a group or individual is received from a user. If the user is logged into the group-centric network, then the user's roles and relationships may be determined for each group of the webpage that the user is attempting to access. As such, the user security level for a user requesting access to the webpage is determined.

One or more security settings associated with data on the webpage is also determined. The security setting may be associated with a data profile of each piece of data on the webpage. Additionally or alternatively, the security setting may be associated with a web part.

Based on the user security level and the one or more security settings, an appropriate level of access and functionality for each piece of data and/or web part on the webpage is provided to the user.

### BRIEF DESCRIPTION OF THE DRAWINGS

FIG. 1 is a block diagram of an environment in which embodiments of the present invention may be practiced.

FIG. 2 is a block diagram of an exemplary hierarchical structure within one organization of the social network.

FIG. 3 is a block diagram of an exemplary social network host.

FIG. 4 is a block diagram of an exemplary accounts engine.

FIG. 5 is a block diagram of an exemplary security engine.

FIG. 6 is a flowchart of an exemplary method for providing access and functionality to a requesting user.

FIG. 7 is a flowchart of an exemplary method for determining access and functionality.

FIG. 8a illustrates an exemplary interface for setting data profile security settings.

FIG. 8b is a screenshot of an example public webpage for an individual;

FIG. 8c is a screenshot of an example “friends only” webpage for the same individual; and

FIG. 8d is a screenshot of an example private webpage for the same individual.

### DETAILED DESCRIPTION OF EXEMPLARY EMBODIMENTS

Embodiments of the present invention provide security systems and methods for a group-centric social network. In exemplary embodiments, security is based on roles and relationships of the user and groups in the network. As such, a user's association with one or more groups is identified and used to determine a level of access to data and enabled functionalities.

In various embodiments, the group-centric social network allows organizations to be represented and made functional over a network, such as the Internet. Groups, projects, and services of each organization may then be connected through managerial, functional, and business relationships, established within and according to an organizational structure. According to some embodiments, the group-centric network may comprise a group-centric social network. In alternative embodiments, the group-centric network may comprise a group-centric enterprise, business, or educational network, or any other type of group based network.

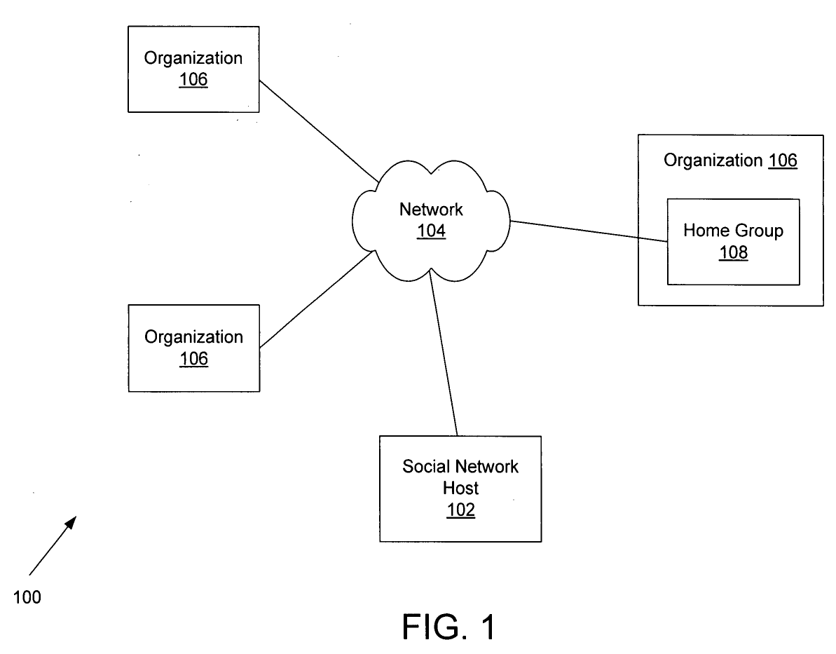

Referring now to FIG. 1 an exemplary environment 100 in which embodiments of the present invention may be practiced is provided. The exemplary environment 100 comprises a group-centric network host 102 coupled via a communications network 104 to a plurality of organizations 106. The communications network 104 may comprise any type of communications network, such as the Internet.

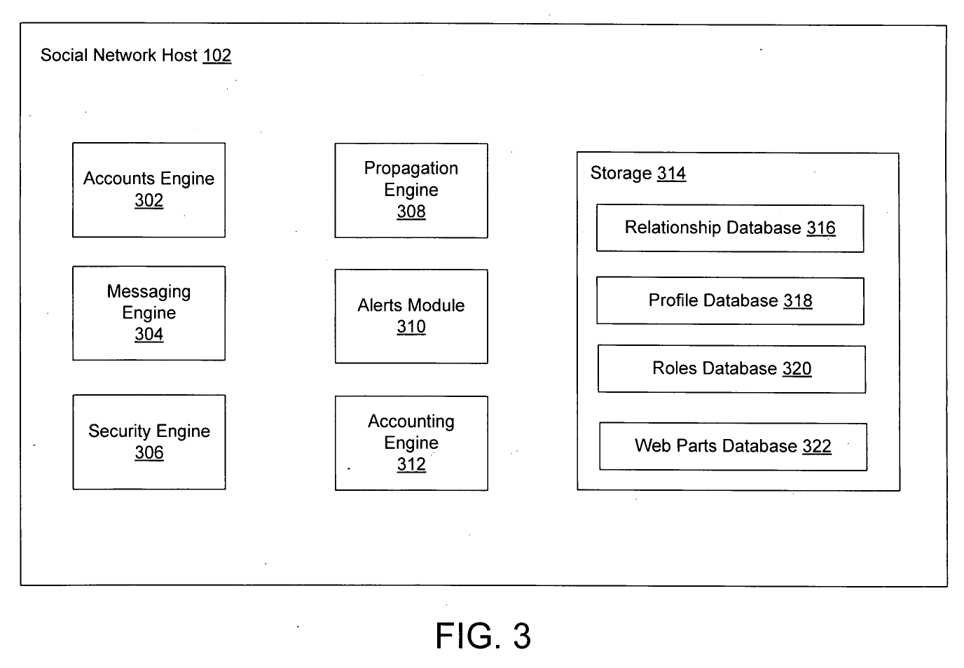

In exemplary embodiments, the social network host 102 comprises one or more servers configured to maintain security for the group-centric network of organizations 106 and groups within the organizations 106. The group-centric network host 102 will be discussed in more details in connection with FIG. 3 below.

The organization 106 represents any entity that desires to establish a presence on the group-centric network. The organization 106 may comprise profit or nonprofit entities. For simplicity of discussion, embodiments of the present invention will be discussed utilizing churches as the organizations 106. However, the organizations 106 may be any type of organizations, such as businesses, franchises, sponsors, universities, retail chains, advertisers, and partners. The sponsors or partners may be organizations 106 which provide goods or services to other organizations 106 on the group-centric network.

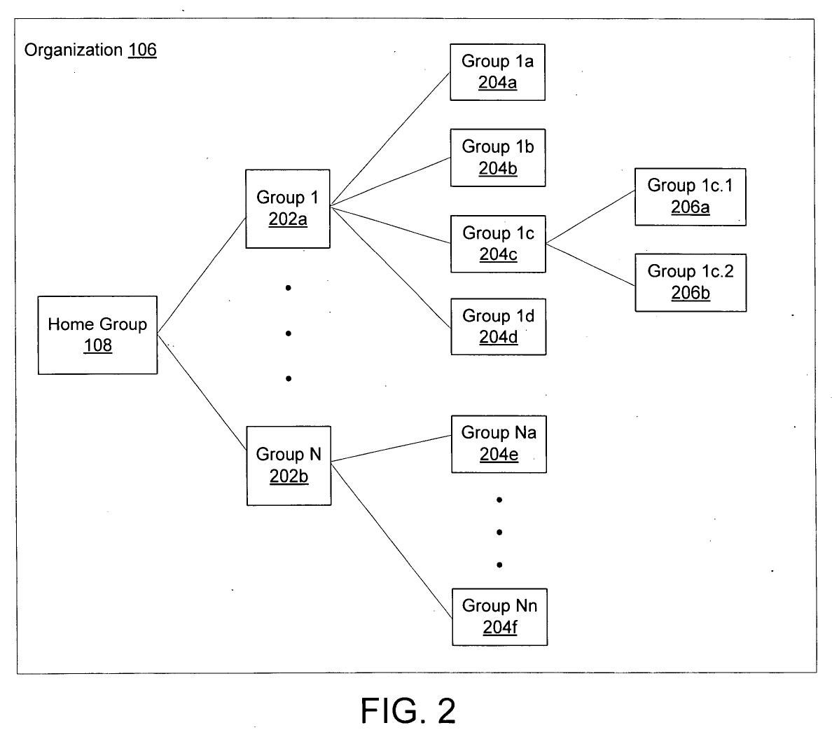

In exemplary embodiments, each organization 106, at a highest level, is represented on the group-centric network as a home group 108. The home group 108 is a highest level group in an organization structure that may be established for the organization 106. Each home group 108, in turn, may be linked to one or more subgroups. These subgroups are termed “child groups” of the home group 108 as they are spawns off of the home group 108 or “parent group.” An example of this organizational structure will be discussed in connection with FIG. 2.

FIG. 1 illustrates one exemplary embodiment of the environment 100 in which embodiments of the present invention may be practiced. Alternative embodiments may comprise any number of organizations 106 coupled to any type of communications network 104. Additionally, more than one group-centric network host 102 may be present.

Referring now to FIG. 2, an exemplary organizational structure for the organization 106 is shown. The overall organization 106 is represented on the group-centric network as the home group 108. The home group 108 may comprises (e.g., be linked to) one or more child groups. In FIG. 2, the home group 108 is shown directly coupled to a plurality of child groups (group 1 202a through group N 202b ). Any number of these first level child groups 202 may be coupled to the home group 108. For example, if the home group represents Wood River Church on the group-centric network, then child group 1 202 a may represent Small Groups Ministry of the Wood River Church.

Furthermore, each first level child group 202 may be coupled to one or more second level child groups. As shown, child group 1 202a comprises a plurality of second level child groups (e.g., group 1a 204a through group 1d 204d). Similarly, child group N 202b is coupled to a plurality of second level child groups (group Na 204e through group Nn 204f). Any number of second level child groups 204 may be established and coupled to the first level child group 202. As a result, the first level child group 202 becomes a parent to the second level child group 204. Alternatively, the first level child group 202 may not be coupled to any second level child groups 204.

Continuing with the example, the Small Groups Ministry may comprise a plurality of small ministry groups, each small ministry group comprising at least one leader and one or more members. These small ministry groups may be referred to as child groups of the Small Group Ministry, which is a parent to the small group.

As further shown, the second level child group 204, itself, may be a parent to third level child groups 206. The organizational structure allows any number of levels of child groups to be established within a single organization 106. Additionally, any number of parent-child relationships may be established within the organizational structure represented on the network 104 with any specific child group having one parent.

Each group within the organization 106 (e.g., home group 108, child groups 202-206) may be defined by its profiles, functions, relationships, and members. The profile comprises basic group information which is provided upon group creation. The group information may include, for example, characteristics, purpose, identification of a group leader, and contact information for the group leader.

The profiles may also comprise security settings for the groups as well as for each individual in the group-centric network. According to one embodiment, the profile may comprise general security settings for all data associated with the group. For example, only logged in group members may be allowed to access data on the group's webpage or profile page. Alternatively, the profile may set default security settings for each component on a webpage created for the group. In this embodiment, the components may comprise different security settings such that some data may be accessed only by group members, and other data, for example, may be accessed by the public. The profiles will be discussed in more detail in connection with FIG. 3.

Each organization 106 may be represented on the network 104 as an organizational structure comprising groups 108 and 202-206 networked together through various relationships. These relationships establish how each group 108, 202, 204, or 206 is coupled within the organizational structure to other groups 108 and 202-206 and individual users. Exemplary relationships may comprise line relationships, lateral relationships, staff relationships, functional relationships, group membership relationships, and individual membership relationships. The line relationship comprises a direct parent-child relationship between two groups 108, 202, 204, or 206 in the organizational structure. For example, there is a parent-child relationship between the home group 108 and first level child group 1 202a.

The lateral relationship comprises a relationship between groups on the same hierarchical level. In the example of FIG. 2, there is a lateral relationship between child group 1 202a and child group N 202b.

The staff relationship comprises a relationship between, for example, an administrative group and other groups 108, 202, 204, or 206 for advisory purposes. For instance, an information technology group may form relationships with a plurality of child groups 202-206 in order to provide technical assistance. A user that is a member of the administrative group may have security settings that allow the user to access certain sections of the webpages of the groups 108, 202, 204, or 206 the administrative group administers. For example, the administrative group member may have associated security settings that allow the member to access and change data on the group webpage.

The functional relationship may comprise a relationship between a special purpose group and other groups 108, 202, 204, or 206. In some embodiments, this relationship comprises a line relationship that relates to the special function of the group. These groups may have a special purpose and, therefore, a limited set of functions the group can perform, which will be reflected in an actual set of web parts available for the group. In one embodiment, the relationship of the special purpose group (e.g., church store) may allow a member of the special purpose group to access and change data on a webpage of another group. For example, a member of the church store may access and edit advertisement for the church store on a group's webpage.

The group membership relationship comprises a relationship that establishes that a group belongs to an organizational structure. This relationship is, in some embodiments, established with the home group 108 of the organization 106. In other embodiments, membership may be between two independent organizations 106 (each one with its own home group 108), wherein one organization 106 is a member of the other organization 106. An example of this comprises a church denomination and its churches. Both are organization 106 having independent group hierarchies with their own home groups 108. However, there is a membership relationship between the home group 108 of each church (e.g., organization 106) of that denomination and an organization 106 of the church denomination hierarchy. A specific example comprises the Orlando Church of the Nazerne, which is a member of the Nazarene Denomination through a relationship of the Orlando Nazarene Church home group with the group “South East Region” of the Nazarene Denomination hierarchy.

The individual membership relationship comprises relationships established between an individual and the group 108, 202, 204, or 206 making that individual a member of that group 108, 202, 204, or 206. Members comprise individuals that participate in the group 108, 202, 204, or 206 in different roles. The roles may comprise leaders, project managers, general members, and so forth. These roles and relationships affect security as will be discussed further below.

Furthermore, there may be two types of relationships: within the organization 106 and outside of the organization 106. Within the organization, there are relationships between groups 108 and 202-206 (e.g., parent and child) and individual relationships (e.g., member, leaders). Outside of the organization 106, relationships may be established between different organizations 106 (e.g., sponsorship, partnership, etc.). In some embodiments, the establishment of relationships may be based on criteria. For example, if a sponsor is looking to sponsor Baptist churches within a 20 mile radius, then a church (i.e., organization 106) fitting these criteria may establish a relationship with this sponsor.

Once approved and activated, each child group 202-206, as well as the home group 108, may be represented on the network 104 by one or more group webpages or profile pages. These webpages may reflect the group's profile, functions, relationships, leadership, and members. As such, the webpages may be customized by each group 108 and 202-206. The customization of the webpages will be discussed in more detail in connection with the web parts discussion in FIG. 3.

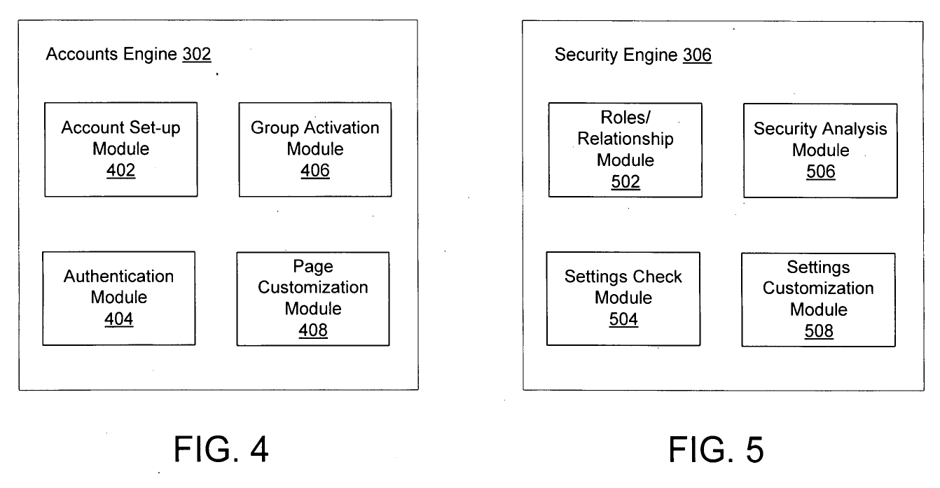

Referring now to FIG. 3, the social network host 102 is shown in more detail. In exemplary embodiments, the social network host 102 comprises an accounts engine 302, a messaging engine 304, a security engine 306, a propagation engine 308, an alerts module 310, an accounting engine 312, and storage 314. The exemplary accounts engine 312 is configured to manage individuals, groups, and organizations 106 on the network 104, and will be discussed in more detail in connection with FIG. 4.

The exemplary messaging engine 304 is configured to provide mechanisms to communicate within the network 104 including providing handshake mechanisms for establishing relationships between groups 104 and 202-206. The messaging engine 304 will, in exemplary embodiments, generate and forward messages (e.g., e-mails) between individuals (e.g., group leaders, administrative staff, users, etc.) in order to establish relationships. For example, messages may be utilized to invite members and leaders for a group. Additionally, messages may be utilized to accept invitations or requests for group members, leadership, and/or activation.

In exemplary embodiments, the security engine 306 limits access and functions within the organization 106 based on roles and relationships of groups 108 and 202-206 and individuals with regards to the organization 106. The security engine 306 will be discussed in more details in connection with FIG. 5 below.

The exemplary propagation engine 308 is configured to propagate data within the organization 106. For example, if a child group has a posting of new events, the new events may be propagated up to the parent group of this child group. As a result, a webpage of the parent group may show the new event on their events calendar. In some embodiments, propagation of data occurs if a profile of the data allows for it. For example, if the data is specific only to a particular group, then the data may not be allowed to propagate up to the next level (e.g., the parent group). In some embodiments, data may be propagated down as well (e.g., from a parent group to child groups) and displayed on the child group webpages.

In exemplary embodiments, the alerts module 310 is configured to provide alerts to an individual based on settings set by the individual, for example, in their profile. As such, the alerts module 310 monitors data within the organization 106 to determine if new data has been posted. If new data is posted, the alerts module 310 determines if any individuals have requested an alert for that new data. For example, when a user accesses their personal webpage, an alert for new events (for groups that the user is a member of) may be provided. Alerts may also be provided for news, blogs, and other information.

The exemplary accounting engine 312 is configured to maintain accounting and billing information for each organization 106. In various embodiments, each organization 106 via the home group 108 subscribes to a particular level of service with the social network host 102. The level of service may determine a certain number of megabytes of storage and bandwidth on the network 104 and types of features available to the groups of the organization 106, for example.

The storage 314 is configured to store various databases associated with the organizations 106, home groups 108, child groups 202-206, and individuals. In exemplary embodiments, the storage 314 comprises a relationship database 316, a profile database 318, a roles database 320, and a web parts database 322. These databases 316-322 are exemplary and alternative embodiments may comprise more or less databases or combine some of the databases 316-322 together. For example, other databases may provide layouts and themes, or store events, news, and blogs.

The exemplary relationship database 316 comprises tables storing relationships between the various organizations 106, groups, and individuals within the network 104. Such relationships may include, but are not limited to, parent-child relationships, sponsor-organization relationships, partner-organization relationships, members-group relationships, advertise-organization relationships, etc.

The exemplary profile database 318 stores profile information for each organization 106, group 108 and 202-206, and individuals. Profile information may comprise name, contact information, security settings, preferences, attributes, and so forth. For each organization 106 (e.g., home group 108) and group, a general profile may be established. In some embodiments, the general profile will comprise default settings including default security settings that will apply to various web part components or data provided by the organization 106 and groups. These default settings may be customized by a group leader or administrator. For example, the security setting may only provide group data to members that are logged in. Similarly, each individual may establish a customized profile and profile pages having settings including security settings.

Profiles may vary depending on a user or group type. For example, a church organization may have different profiles for a house church type group and a youth group. The individual may have a different profile (e.g., more than one profile) based on age, user type, and/or if the individual belongs to more than one user type. For example, an individual who is a missionary may have an additional profile or profile data element if the individual is also a filmmaker. In this case, the profile may be extended to encompass additional profile data elements particular to a filmmaker. The profile extension also applies to groups. For example, a group called “Youth with a Mission” may fit the profile of both a youth group and a missionary group. The group profile for this group may include data elements for both group type profiles. Additionally, profiles may be extended based on surveys responded to for users, individuals, and groups. The profiles may be utilized to establish associated profile pages (i.e., webpages) unique to each group or individual.

The roles database 320 may, in some embodiments, store an individual's roles (e.g., responsibilities and permissions within a group). These roles may, in one embodiment, be based on relationships between individuals and the home group 108 and/or child groups 202-206. These roles may, for example, identify the individual as a manager or leader of the group 108 or 202-206 (e.g., power over functions performed within the group and has access to all information handled by the group), officer or member (e.g., has limited powers to perform functions and access information as defined by the group manager), and administrator (e.g., responsible for technical and administrative maintenance of the group). As a result, the role of the individual also determines access and functionalities enabled for the individual within the group and/or organization 106.

In exemplary embodiments, the web parts database 322 comprises components that are provided to customize a webpage or profile page. Icons representing these web parts may be shown, for example on a pop-up window or on a side of the webpage. The individual (e.g., group leader) may drag and drop an appropriate icon onto a location of the webpage where the selected component should appear in order to customize the webpage. In some embodiments, the web parts components also enable functions on the webpages.

For example, when a child group 202-206 is activated on the network 104, the webpage for the child group 202-206 may be preloaded with a default set of web parts. A leader of the child group 202-206 may change the webpage by, for example, accessing the web parts database 322 and dragging and dropping icons representing components such as an event component (e.g., enables events to be posted on a calendar), news component (e.g., allows news to be posted on the page), media components (e.g., allow media, photos, etc. to be posted), and so forth. These web parts components also allow a leader or administrator to define how information is propagated up, alerts are set, and notifications sent. Once web parts components are dropped on the webpage(s), then, according to some embodiments, information may be provided or uploaded to fill in blank templates generated by the web part components.

In some embodiments, the dragged and dropped web parts components may be customized to select which of the groups underneath the present group (e.g., a group's child groups) may be featured on the group's site. This results in propagation up of events, news, or other information from the child groups to the present group. For example, if a new event is posted in child group 1a 204a, this new event information may propagate up to a webpage of group 1 202a.

Each web part component may allow the individual to select or set a security setting. In some embodiments, a default security setting is associated with the web part component, which may be altered by the individual administering the webpage. For example, an events web part component for a group may have a default security setting that only members of the group may view the events and only leaders of the group may administer (e.g., update) the events web part component. The individual may then change the security setting to allow, for example, non-members (e.g., public) to view the events as well.

As such, the web part security is based on roles and relationships which determine functionality and access rights available to a user accessing the web part. For example, a small group page may have a note card, a blog, and a calendar web part. The note card web part may be configured to be viewed only by members of the small group, and allow only members to post to the note card. This limits the note card to internal group use only. The blog may be configured to be viewed by the public, but only leaders can post to the blog, and only members may comment on the blog. Finally, the calendar of events may be set to be updated by leaders only and viewed only my members. These security settings may not be profile-based but are specified by editing the web part preferences.

As such, embodiments of the present invention allow configuration of a webpage to one or more different views/access of its content and functionality. For example, one view may be configured for leaders, which will allow for leadership functions and show information pertinent only to the leaders, such as posting a blog or entering a calendar event. A second view may be configured for members which allow for member functions such as confirming attendance to a group event or commenting on a blog. These first two levels of views allow the small group to conduct its activities over the network through the interaction between leaders and members that is not viewable by the public or individuals not associated with the small group. A third view may be configured for the public, providing only information about the small group pertinent to the general public such as regular informational websites provide.

In exemplary embodiments, when data is provided into the web part, an associated data profile may be customized. This data profile may comprise a security setting, which can specify how particular data is to be viewed by a user accessing that webpage based on a user's role and relationship with respect to the group or individual's webpage being accessed. For example, a small group may have its general information available to the public, but its address available only to members, and the phone number of that group available only to its leaders.

It should be noted that the security settings in the data profile may work in conjunction with the web part security setting. The data profile may specify how information about the group is to be viewed by a user accessing that webpage based on the user's relationship to that group. The web part security is also based on relationships and roles, but it specifies the functionality and access rights made available to a user accessing that web part based on the user's relationship and role to that group webpage. For example, a “contact info” web part may be set to a public security setting. However, specific data within the web part, such as e-mail address, may be set to be viewable only by members. As a result, the web part will display to the public, but the profile content set to members (e.g., e-mail address) will not be displayed unless the viewer is a member.

Referring now to FIG. 4, the accounts engine 302 is shown in more detail. The accounts engine 302 is configured to manage groups on the network 104 by setting up and maintaining data for each account (e.g., individual, group, and organization 106) on the network 104. The accounts engine 302 may comprise an account set-up module 402, an authentication module 404, a group activation module 406, and a page customization module 408.

The exemplary account set-up module 402 is configured to provide a graphic interface which is utilized to establish an account with the network 104. The account may be for an individual, a group, or a home group 108. In exemplary embodiments, the graphical interface provides a plurality of fields where an individual or group creator enters information including profile and relationship information. The profiles may comprise general security settings for the individual, group, or home group 108. With regards to a home group account, billing and service plan information for the organization 106 is also received by the account set-up module.

The authentication module 404 authenticates individuals accessing the network 104. In some embodiments, the authentication module 404 will verify user names and passwords of individuals accessing webpages of the organization 106 and/or groups 202-206 by comparing an entered user name and password with one stored in the profile database 318.

When the child group (e.g., child group 1 202a) account is set-up, the relationship of the child group 202a within the organization 106 is inactive until the associated home group 108 approves of the child group 202a. This approval process insures that the home group 108, which is paying for the social network service provided by the social network host 102, has control over use of resources subscribed to by the organization 106. As such, the group activation module 406 is configured to process the group approval process.

The exemplary page customization module 408 is configured to allow the creator or leader of the child group 202a to customize the group's webpage and allow an individual to customize their personal webpage. In exemplary embodiments, a default webpage is initially associated with the group or individual. Web parts components may, in some embodiments, be used to customize the webpage, as described above. The page customization module 408 provides access to these web parts components in the web parts database 322. In some embodiments, these web parts components may have default security settings, which the user may customize. In some embodiments, the page customization module 408 also provides the customized webpages/profile pages to a requesting user. In other embodiments, another component of the social network host 102 generates and provides the requested webpage.

Referring to now to FIG. 5, the exemplary security engine 306 is shown in more details. The security engine 306 is configured to limit access and functions within the organization 108 based on roles and relationships of groups 108 and 202-206 and individuals. In exemplary embodiments, the security engine 306 comprises a roles/relationship module 502, a settings check module 504, a security analysis module 506, and a settings customization module 508. Alternative embodiments, may comprise functionally equivalent modules.

In some embodiments, data posted on a group's webpage may be made private. This private data may only be accessed by, for example, group leaders. In some embodiments, access and functionality for each piece of data may be set in a profile for the data which is established when the data is posted to the webpage. In other embodiments, access and functionality is determined by the security setting of the web part component in which the data is posted. For example, a general member of a group may not be permitted to change the news and events posted on a group webpage, but only be allowed to view the content because news and events web parts comprise security settings with these requirements.

In various embodiments, there are a plurality of security settings including, but not limited to, public/everyone (e.g., anyone can view but cannot edit), members only (e.g., must be a member to view and in some situations can edit), leaders only (e.g., only leaders can view and in some situations can edit), administrative (e.g., can view everything and can edit), and friends. Alternative embodiments may comprise other security settings and/or any combination of these security settings. The security engine 306 will determine based on these security settings whether an individual accessing the data is permitted to view the data and/or perform some function on the data (e.g., modify, delete, add, etc.).

The exemplary roles/relationship module 502 is configured to determine the security level of the user accessing the webpage. The user may have a different level of access and functionality within the same organization. For example, the user may be a member and leader of a third level group, but a general member of a second level group. Therefore, the exemplary roles/relationship module 502 will determine what the security level (e.g., roles and relationships) associated with the user is with respect to the group/individual webpage the user is currently requesting to view or access.

In exemplary embodiments, the roles/relationship module 502 will access the roles database 320. If the user has logged into the group-centric network, then the roles/relationship module 502 will access the data associated with the user in the roles database 320. According to one embodiment, the roles database 320 is organized as a series of tables. The tables will indicate the user's role with respect to each group in the organization and, in some embodiments, to each individual. Thus, by knowing the user's identity and the group or individual webpage being accessed, the roles/relationship module 502 will determine the user security level (e.g., roles and relationships) with respect to the webpage being accessed.

The exemplary settings check module 504 is configured to determine the security setting for the data on the webpage currently being accessed by the user. In exemplary embodiments, each web part component on the webpage comprises at least one security setting. In some embodiments, the data profile contains further security setting specific to the data in the web part. Therefore some embodiments utilize a combination of both the data profile and the web parts component to comprise the security settings. webpage

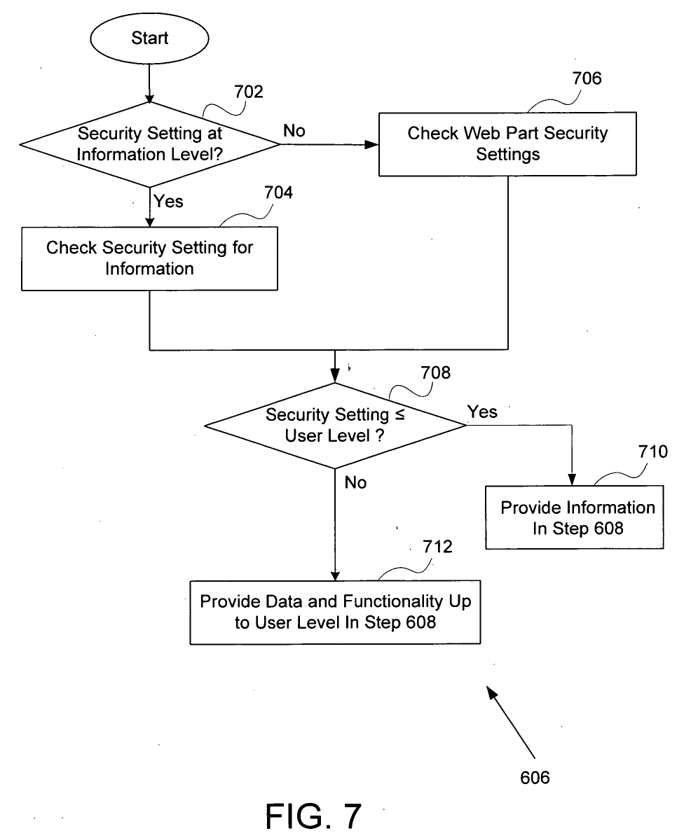

Based on the user security level and the security setting of the data on the webpage being access, the security analysis module 506 determines what data may be provided to the user. Additionally, the security analysis module 506 may determine the level of functionality allowed to the user. For example, the user may be allowed to post data to a particular web part component, but not allowed to delete any data. The security analysis process will be discussed in more detail in connection with FIG. 7.

The settings customization module 508 allows individuals (e.g., administrative staff or group leaders) to customize the security setting of the data and/or web parts. In various embodiments, a default data security setting is associated with the data (e.g., in the data profile) and/or web part (e.g., associated with the web part component). The settings customization module 508 may change the security setting from the default setting. In some embodiments, the settings customization module 508 is optional or the functions of the settings customization module 508 may be embodied in other components of the group-centric network host 102. For example, the security settings of the data may be set by the propagation engine 308 and/or the security settings for the web part may be customized by the page customization module 408 when the web part component is dragged and dropped onto the webpage.

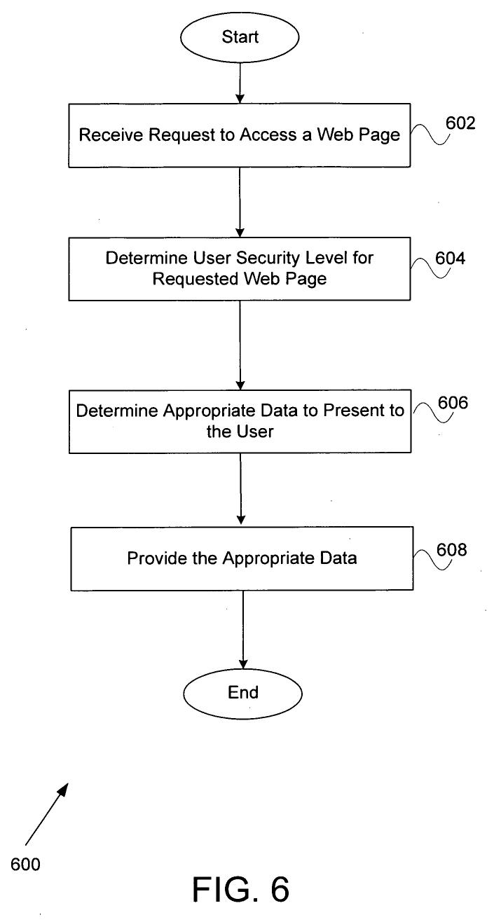

Referring now to FIG. 6, a flowchart 600 of an exemplary method for providing access and functionality to a webpage or profile page is provided. In step 602, the group-centric network host 102 receives a request to access a particular webpage associated with a group or individual of the organization 106. The request may comprise the user selecting the particular webpage via selecting a link, entering a URL, or utilizing any other navigation mechanism. The request is then forwarded to the security engine 306.

The security level of the user for the request webpage is determined in step 604. In exemplary embodiments, the roles/relationship module 502 determines the identity of the requesting user. For example, the user may have logged into the group-centric network. Based on the user's identity and associated group of the webpage being requested, the roles/relationship module 502 accesses the roles database 320 and determines the user's security level for that particular group, and thus the security level for the requested webpage. If the user has not logged in, then the roles/relationship module 502 may assign the user a public security level.

In step 606, the security setting of the various data on the webpage is determined. In some embodiments, different sets of data and/or web parts on the same webpage may comprise different security settings. For example, a news web part component may have a lower security setting such that members of the public may view the news. However, the same webpage may comprise an events web parts component which requires the user to be a member or leader in order to access the associated data. The security setting for each piece of data and/or web part component is determined in step 606. The determination process will be discussed in more details in connection with FIG. 7. In step 608, the appropriate data and functionality is provided to the user.

Referring now to FIG. 7, a flowchart of an exemplary method for determining the appropriate level of access and functionality (i.e., step 606) is shown. In step 702, the settings check module 504 determines if the security setting is set in the data profile. If the security setting is set in the data profile, then the security setting is determined for the data in step 704. However, if the data profile does not comprise the security setting, then the security setting at the web part component is reviewed in step 706. For example, a news article may be posted on the webpage without any security setting set in the news articles profile. As such, the new web parts component profile is reviewed to determine the security level which will apply to the news article. In some embodiments, the security setting of the web part component may be automatically incorporated into the data profile. Thus, step 706 may not be needed.

In step 708, the security analysis module 506 determines if the security setting for each piece of data and/or web part component is lower or equal to the user security level. In exemplary embodiments, the user security level ranges from public (lowest security level) to member (medium security level) to leader (highest security level). A user security level may also comprise a “friends” setting. In some embodiments, an administrative security level may be provided which allows complete access and functionality. It should be noted that in various embodiments, the leaders or administrative individuals may customize the security settings and levels of access and functionality associated with each security setting, and that other user security levels may be implemented.

If the security setting for the data and/or web part component is lower or equal to the user security level, then the data and associated functionality is provided to the user in step 710. However, if the security setting for the data and/or web part component is higher than the user security level, then the user may be provided only data and functionality configured for access up to the security level of the user in step 712. Therefore, if the user security level is “member,” then the user will have access to any public and member data and will have any functionalities allowed for the public and members. However, the user will not have access or functionality provided to any leader or administrative staff. In some embodiments, access to data may comprise access to general/public data. The general/public data may comprise, for example, a blank section, generic data, or an invitation to join the organization 106 or group.

The process described in FIG. 7 may be repeated as many times as needed for each piece of data and/or web part that is embodied on the webpage being accessed.

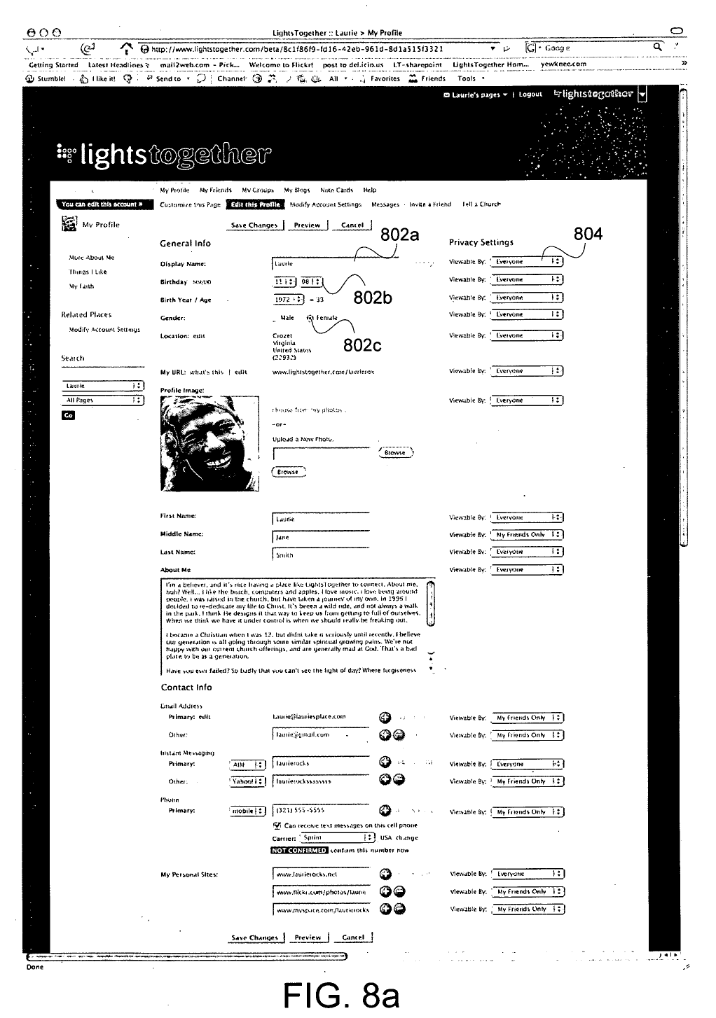

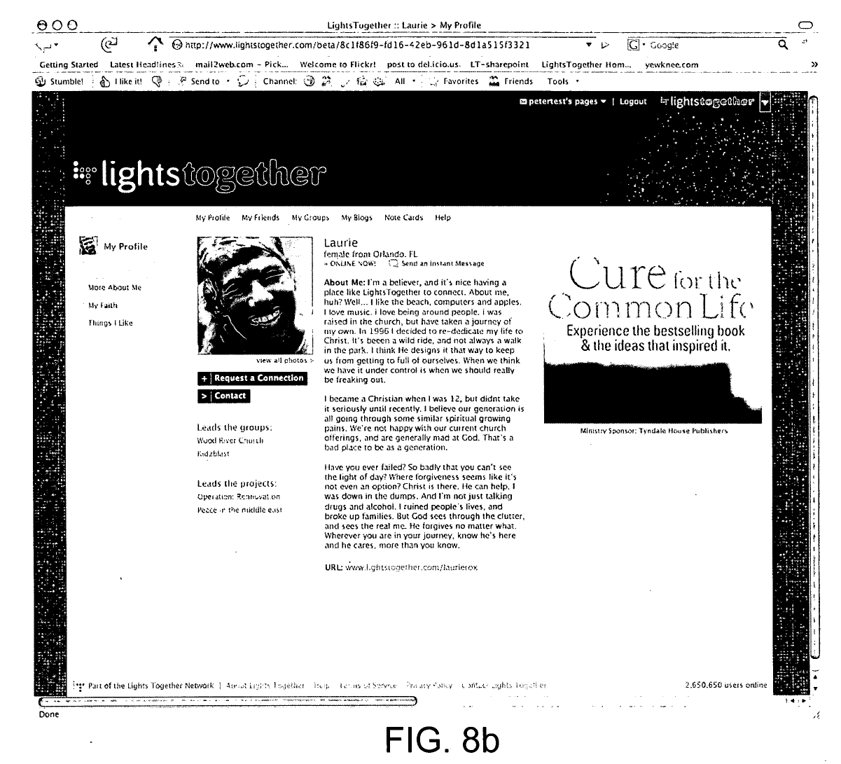

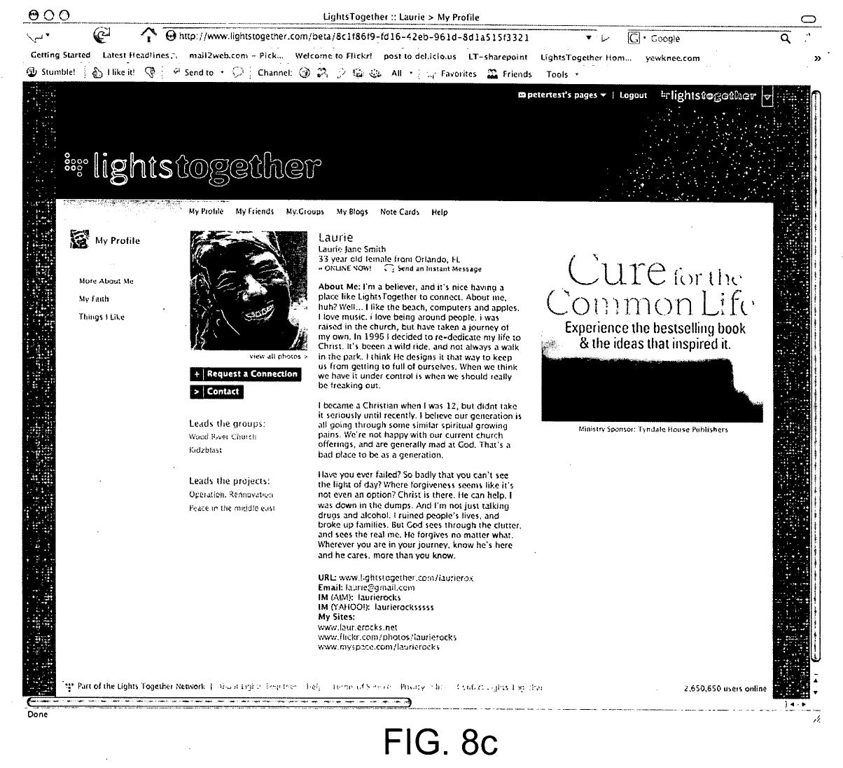

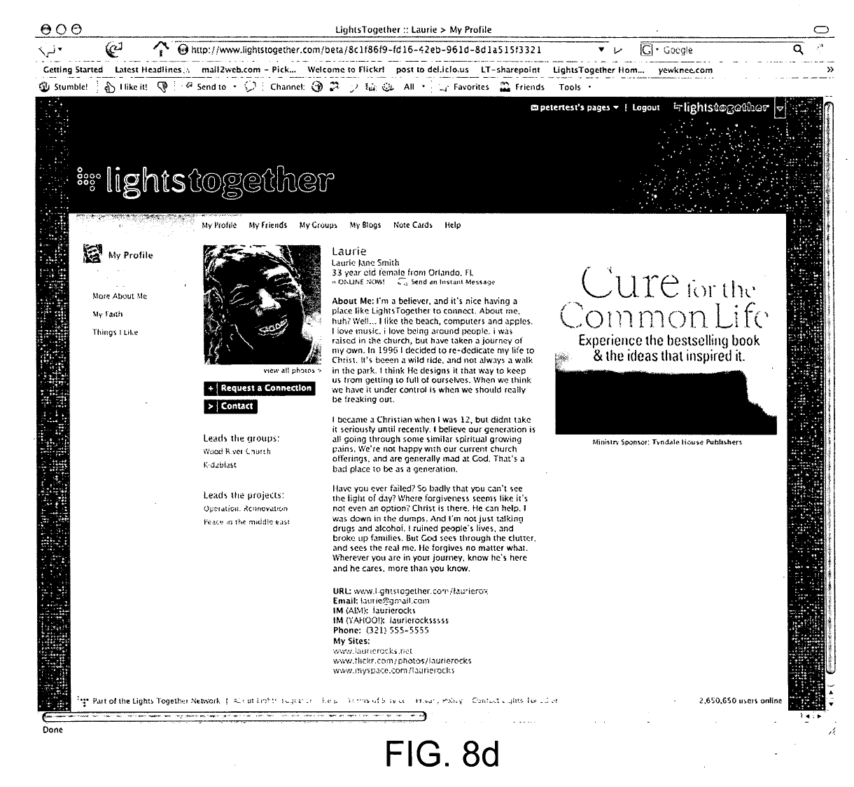

Referring now to FIG. 8a, an example interface for setting security for data in a data profile is shown. This example illustrates security settings for an individual's profile which may be used, for instance, to create the individual's own webpage or profile page. An entry on the interface may provide no security settings (e.g., e-mail address). As a result, this piece of data is available to anyone accessing the information. Other entries allow the individual to set the security setting. For example, a first name may be viewed by everyone, while only friends are allowed to view a middle name, and the date of birth is only viewable by the members. Security settings for functions associated with a webpage may be set in a similar manner.

According to exemplary embodiments, the user enters information into information fields 802. These fields 802 may comprise text boxes 802a, drop down menus 802b, selections 802c, or any other mechanism for providing/selecting data.

Some or all of these information fields 802 may be associated with a security (privacy) setting field 804. In the present embodiment, the security setting field 804 is shown as a drop down menu. Alternative embodiments may utilize other mechanisms for setting the security level. In exemplary embodiments, security settings may comprise everyone (i.e., public), friends only, members, leaders, and private, for example. Other security settings may be utilized or security settings may be combined. For example, a private security setting may be accessed by a leader.

While the security setting interface of FIG. 8a is provided to set security for an individual's profile, a similar security setting interface may be provided for setting security for a group's profile. That is, information fields 802 and security setting fields 804 may be provided to a group leader or administrator for setting security for some or all data of the group. It should be noted that the information fields 802 of the individual and group profiles may differ and be, in part, based on their roles and relationships in the network.

Referring now to FIG. 8b, a public profile page (i.e., webpage) for an individual is shown. In this public profile page, the individual's age, full name, phone number, e-mail address, IM identities, and website address are hidden from view. As such, a user that is not logged in or not a member of the groups associated with the individual may view this public profile page and have limited access to information from the individual.

FIG. 8c shows a “friends only” profile page (i.e., webpage) for the same individual. This profile page comprises additional information over the public profile page. For example, the individual's age, e-mail address, IM identities, and website addresses are provided to the registered friends.

FIG. 8d illustrates a private profile page (i.e., webpage). This private profile page may be viewable, for example, by a leader and members of a group that the individual belongs to. In this private profile page, the individual's phone number is available along with all the additional information found on the “friends only” profile page.

It should be noted that, in exemplary embodiments, a highest security level of a user is used to determine the level of access to the profile data. For example, if a user is both a registered friend to the individual and also a member of the same group as the individual, then the user's security level as a member would be used to determine the level of access to the individual's profile data. In this example, the user would access the individual's private profile page.

While FIG. 8b-FIG. 8d show examples of an individuals profile pages, it should be noted that a group or organization's profile pages may be provided using similar mechanism. That is, for example, public and a private (member's only) profile pages for the group may be generated and provided to users based on the user's security levels. The private profile pages may comprise more information (e.g., phone numbers and contact addresses) then those of the public profile pages. Thus, in exemplary embodiments, the profile pages are generated on-the-fly based on the user's security level.

It should be noted that since the security mechanisms of the present invention are built into the framework, new roles and relationships may be created, new profiles types or data elements may be added, and new web parts catalogued without disrupting the security system.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for providing security in a group-centric network, comprising:
receiving a request to access a webpage associated with a group or individual;
determining a user security level for a user requesting access to the webpage;
determining one or more security settings of data associated with the requested webpage; and
generating and providing the requested webpage to the user, the requested webpage comprising appropriate data and functionality based on the user security level and the one or more security settings.

2. The method of claim 1 wherein determining the user security level comprises determining one or more roles and relationships of the user with respect to the group or individual.

3. The method of claim 1 wherein determining the user security level comprises determining if the user is authenticated.

4. The method of claim 1 wherein determining one or more security settings comprises reviewing one or more data profiles associated with data on the webpage.

5. The method of claim 1 wherein determining one or more security settings comprises reviewing security settings associated with a web part.

6. The method of claim 1 further comprising comparing the user security level to the one or more security settings to determine the appropriate access and functionality.

7. The method of claim 1 wherein providing appropriate access and functionality comprises providing public information if the user security level is lower than the one or more security settings.

8. The method of claim 1 further comprising providing at least one security setting for each piece of data.

9. The method of claim 1 further comprising providing a security setting for a web part of the webpage.

10. A system for providing security in a group-centric network, comprising:
a settings check module configured to determine security settings for each piece of data on a webpage being requested;
a roles/relationship module configured to determine a security level for a user requesting the webpage; and
a security analysis module configured to determine appropriate data and functionality to provide the user based on the security level and the security settings; and
a page customization module configured to generate and provided the request webpage comprising the appropriate data and functionality.

11. The system of claim 10 further comprising a settings customization module configured to allow customization of security settings associated with the data or a web part.

12. The system of claim 10 wherein the security level comprise roles and relationships of the user.

13. The system of claim 12 further comprising a relationship database for storing one or more relationships of the user with respect to the webpage being accessed.

14. The system of claim 12 further comprising a roles database for storing one or more roles of the user with respect to the webpage being accessed.

15. The system of claim 10 further comprising an authentication module configured to identify the user in the group-centric network.

16. A machine readable medium having embodied thereon a program, the program having instructions operable by a machine for providing security in a group-centric network, the method comprising:
receiving a request to access a webpage associated with a group or individual;
determining a user security level for a user requesting access to the webpage;
determining one or more security settings of data associated with the requested webpage; and
generating and providing the requested webpage to the user, the requested webpage comprising appropriate data and functionality based on the user security level and the one or more security settings.

17. The machine readable medium of claim 16 wherein determining the user security level comprises determining one or more roles and relationships of the user with respect to the group or individual.

18. The machine readable medium of claim 16 wherein determining the user security level comprises determining if the user is authenticated.

19. The machine readable medium of claim 16 wherein the method further comprises comparing the user security level to the one or more security settings to determine the appropriate access and functionality.

20. The machine readable medium of claim 16 wherein providing appropriate access and functionality comprises providing public information if the user security level is lower than the one or more security settings.
